(19) United States
(12) Patent Application Publication
(10) Pub. No.: US 2026/0254501 A1
(43) Pub. Date: Aug. 27, 2026

(54) OVERLAPPING BASIC SERVICE SET CHANNEL SOUNDING PROCEDURE FOR COORDINATED BEAMFORMING SCENARIOS

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/434,741

(22) Filed: Dec. 29, 2025

Related U.S. Application Data
(60) Provisional application No. 63/764,419, filed on Feb. 27, 2025.

(51) Int. Cl. H04B 7/06; H04B 7/024; H04L 1/00; H04W 48/08

(52) U.S. Cl. CPC H04B 7/0626; H04B 7/024; H04L 1/0003; H04L 1/0009; H04W 48/08

(57) ABSTRACT

Disclosed herein is a method performed by a station (STA) associated with a first access point (AP) operating a first basic service set (BSS) to participate in an overlapping basic service set (OBSS) channel sounding procedure. The method includes receiving a null data packet (NDP) frame transmitted by a second AP operating a second BSS, generating channel state information for a link between the STA and the second AP based on the NDP frame, and responsive to receiving a trigger frame from the first AP that solicits channel state information, transmitting a channel state information feedback frame that is meant to be overheard by the second AP, wherein the channel state information feedback frame includes a multi-user exclusive beamforming report field that is repurposed to carry information other than multi-user exclusive beamforming report information.

### CROSS-REFERENCE TO RELATED APPLICATION

This application claims the benefit of U.S. Provisional Application No. 63/764,419, filed Feb. 27, 2025, titled “Co-BF compressed beamforming/CQI report design for beyond IEEE 802.11be”, which is hereby incorporated by reference.

### TECHNICAL FIELD

The present disclosure generally relates to wireless communications, and more specifically, relates to an overlapping basic service set (OBSS) channel sounding procedure for coordinated beamforming scenarios.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

When multiple access points (APs) are deployed in an environment, the performance of wireless networks (e.g., Wi-Fi network) can be degraded due to limited bandwidth and interference between APs. AP cooperative transmission schemes (also referred to as AP coordination schemes or multi-AP coordination schemes) are being considered as a potential solution to improve wireless network performance (e.g., improve overall throughput) in environments with densely deployed APs. With AP cooperative transmission schemes, multiple APs can cooperate with each other to enhance wireless network performance (e.g., to improve the throughput of stations (STAs) located in areas covered by multiple basic service sets (BSSs)).

One example of a multi-AP coordination transmission scheme is coordinated beamforming (co-BF or C-BF). With coordinated beamforming, multiple APs may coordinate with each other to simultaneously transmit data on the same frequency resource while forming spatial nulls to reduce interference.

The APs that wish to participate in coordinated beamforming need to obtain channel state information from in-BSS STA(s) (STA(s) associated with the AP) as well as overlapping basic service set (OBSS) STA(s) (STA(s) associated with a different AP). The APs may perform an OBSS channel sounding procedure to obtain the channel state information. With existing OBSS channel sounding procedures in a coordinated beamforming scenario, a STA may transmit a channel state information feedback frame (e.g., a compressed beamforming/channel quality indicator (CQI) frame) to its associated AP that is actually meant to be overheard by an OBSS AP with respect to the STA. However, the OBSS AP might not be able to reliably overhear the channel state information feedback frame (e.g., due to poor link quality) and/or the channel state information feedback frame may carry information that is redundant/unnecessary, which adds overhead.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing an example of coordinated beamforming being performed in a wireless network, according to some embodiments.

FIG. 11 is a diagram showing an overlapping basic service set (OBSS) channel sounding procedure, according to some embodiments.

FIG. 12 is a diagram showing an example of feeding back OBSS channel information, according to some embodiments.

FIG. 13 is a diagram showing a high efficiency (HE) compressed beamforming/channel quality indicator (CQI) frame action field format, according to some embodiments.

FIG. 14 is a diagram showing an extremely high throughput (EHT) compressed beamforming/CQI frame action field format, according to some embodiments.

FIG. 15 is a diagram showing an EHT compressed beamforming/CQI report field format, according to some embodiments.

FIG. 16 is a diagram showing an OBSS channel sounding procedure in a multi-user (MU) scenario, according to some embodiments.

FIG. 17 is a diagram showing an example of how channel state information is transmitted when the MU exclusive beamforming report field is not repurposed, according to some embodiments.

FIG. 18 is a diagram showing an example of repurposing the MU exclusive beamforming report field, according to some embodiments.

FIG. 19 is a diagram showing an example of using synchronized timing to transmit data during coordinated beamforming, according to some embodiments.

FIG. 20 is a flow diagram showing a method for participating in an OBSS channel sounding procedure, according to some embodiments.

FIG. 21 is a diagram showing examples of information that can be included in a multi-user exclusive beamforming report field, according to some embodiments.

FIG. 22 is a flow diagram showing a method for performing an OBSS channel sounding procedure, according to some embodiments.

FIG. 23 is a diagram showing examples of how information extracted from a multi-user exclusive beamforming report field can be used, according to some embodiments.

### DETAILED DESCRIPTION

The present disclosure generally relates to wireless communications, and more specifically, relates to an overlapping basic service set (OBSS) channel sounding procedure for coordinated beamforming scenarios.

Institute of Electrical and Electronics Engineers (IEEE) 802.11 wireless networking standards define an in-BSS (basic service set) channel sounding procedure (for a single BSS). The in-BSS channel sounding procedure allows an access point (AP) to obtain channel state information for in-BSS (basic service set) links (e.g., links between the AP and STAs that are associated with the AP). With this in-BSS channel sounding procedure, a STA may transmit a channel state information feedback frame (e.g., a compressed beamforming/channel quality indicator (CQI) frame) to the AP that includes one or more of the following fields depending on the feedback type: 1) a compressed beamforming/CQI report field; 2) a multi-user (MU) exclusive beamforming report field; and 3) a CQI report field. Specifically, when the feedback type is SU feedback, the channel state information feedback frame may include the) compressed beamforming/CQI report field, when the feedback type is MU feedback, the channel state information feedback may include the compressed beamforming/CQI report field and the MU exclusive beamforming report field, and when the feedback type is CQI feedback, the channel state information feedback may include the CQI report field.

In contrast to the in-BSS channel sounding procedure, an OBSS channel sounding procedure allows an AP to obtain channel state information for OBSSs links (e.g., links between the AP and STAs that are associated with a different AP). With the existing OBSS channel sounding procedure, a STA may transmit a channel state information feedback frame (e.g., a compressed beamforming/channel quality indicator (CQI) frame) to its associated AP that is actually meant to be overheard by an OBSS AP with respect to the STA. However, the OBSS AP might not be able to reliably overhear the channel state information feedback frame (e.g., due to poor link quality) and/or the channel state information feedback frame may carry information that is redundant/unnecessary, which adds overhead.

The present disclosure introduces a technique for a STA to provide additional information to an OBSS AP that can help enhance coordinated beamforming performance and/or reduce the overhead of the OBSS channel sounding process. The technique may repurpose the MU exclusive beamforming report field to provide information other than MU exclusive beamforming information. With an OBSS channel sounding procedure, when a STA transmits a channel state information feedback frame that is meant to be overheard by an OBSS AP with respect to the STA, the MU exclusive beamforming information field may be irrelevant for the OBSS AP. Based on this recognition, the technique disclosed herein may repurpose the MU exclusive beamforming report to provide information other than MU exclusive beamforming report information.

According to some embodiments, a first AP operating a first BSS may transmit a null data packet announcement (NDPA) frame to cause a second AP operation a second BSS to transmit a null data packet (NDP) frame. Responsive to overhearing the NPDA frame, the second AP may transmit the NDP frame. Responsive to receiving the NPDA frame and the NDP frame, a STA that is associated with the first AP may generate channel state information for the link between the STA and the second AP based on the NDP frame. The first AP may then transmit a trigger frame to the STA that solicits channel state information. Responsive to receiving the trigger frame, the STA may transmit a channel state information feedback frame to the first AP that is meant to be overheard by the second AP. The channel state information feedback frame may include the channel state information for the link between the STA and the second AP. The channel state information feedback frame may include a MU exclusive beamforming report field that is repurposed to carry information other than MU exclusive beamforming report information because the channel state information feedback frame is meant to be overheard by the second AP, which is an OBSS AP with respect to the STA. Upon overhearing the channel state information feedback frame, the second AP may extract the information carried in the MU exclusive beamforming report field included in the channel state information feedback frame. The second AP may then perform coordinated beamforming with the first AP. The second AP may use the information extracted from the repurposed MU exclusive beamforming report field to perform coordinated beamforming and/or to perform channel sounding.

The MU exclusive beamforming report field may be repurposed in various ways. In an embodiment, the information carried in the MU exclusive beamforming report field includes at least part of the channel state information for the link between the STA and the first AP. In this case, the second AP may apply nulling towards the STA (that is associated with the first AP) using the channel state information for the link between the STA and the first AP (including the information extracted from the repurposed MU exclusive beamforming report field) when performing the coordinated beamforming with the first AP.

In an embodiment, the information carried in the MU exclusive beamforming report field includes information indicating that nulling (towards the STA) was not successfully performed during a previous coordinated beamforming performed by the first AP and the second AP. In this case, when performing the coordinated beamforming with the first AP, the second AP may apply nulling toward the STA differently from how nulling was applied toward the STA in the previous coordinated beamforming performed by the first AP and the second AP.

In an embodiment, the information carried in the MU exclusive beamforming report field includes information regarding a received signal strength of the NDP frame (transmitted by the second AP) at the STA. In this case, when performing the coordinated beamforming with the first AP, the second AP may determine a transmit power to use for transmitting a data frame to a second STA that is associated with the second AP based on the information regarding the received signal strength of the NDP frame at the STA. The second AP may then transmit a data frame to the second STA using the determined transmit power (e.g., perform power control to reduce interference at the STA associated with the first AP).

In an embodiment, the information carried in the MU exclusive beamforming report field includes information regarding a carrier frequency offset (CFO) and/or a sampling frequency offset (SFO) of the NDPA frame (transmitted by the first AP) and the NDP frame (transmitted by the second AP). In such case, when performing the coordinated beamforming with the first AP, the second AP may synchronize timing between the first AP and the second AP based on the CFO and/or the SFO of the NDPA frame and the NDP frame. The second AP may use the synchronized timing to perform coordinated beamforming and/or to perform channel sounding. For example, if the second AP receives a coordinated beamforming trigger frame from the first AP, the second AP may transmit a data frame to a second STA that is associated with the second AP after an interframe space interval (e.g., short interframe space (SIFS) interval) after receiving the coordinated beamforming trigger frame using the synchronized timing. Additionally or alternatively, if the second AP receives a second NDPA frame transmitted by the first AP, the second AP may transmit a second NDP frame after an interframe space interval (e.g., SIFS interval) after receiving the second NDPA frame using the synchronized timing.

In an embodiment, the information carried in the MU exclusive beamforming report field includes information regarding a phase of the NDPA frame and the NDP frame (e.g., phase difference information and/or phase noise information). In such case, when performing the coordinated beamforming with the first AP, the second AP may determine a phase to use for transmitting a data frame to a second STA that is associated with the second AP based on the phase information extracted from the MU exclusive beamforming report field.

Embodiments may repurpose the MU exclusive beamforming report field to carry information that can help enhance coordinated beamforming and/or channel sounding. It is recognized by the present disclosure that when a STA transmits a channel state information feedback frame (e.g., a compressed beamforming/CQI frame) that is meant to be overheard by an OBSS AP with respect to the STA, the contents of the MU exclusive beamforming report field included in the channel state information feedback frame may be irrelevant for the OBSS AP. Thus, embodiments may repurpose the MU exclusive beamforming report field to carry other information that can be useful for the OBSS AP to perform coordinated beamforming and/or to perform channel sounding. As used herein, “repurposing” of a field or similar phrase may refer to using an existing field (e.g., a field that is defined in a wireless networking standard) to carry information other than what it is originally designed to carry.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

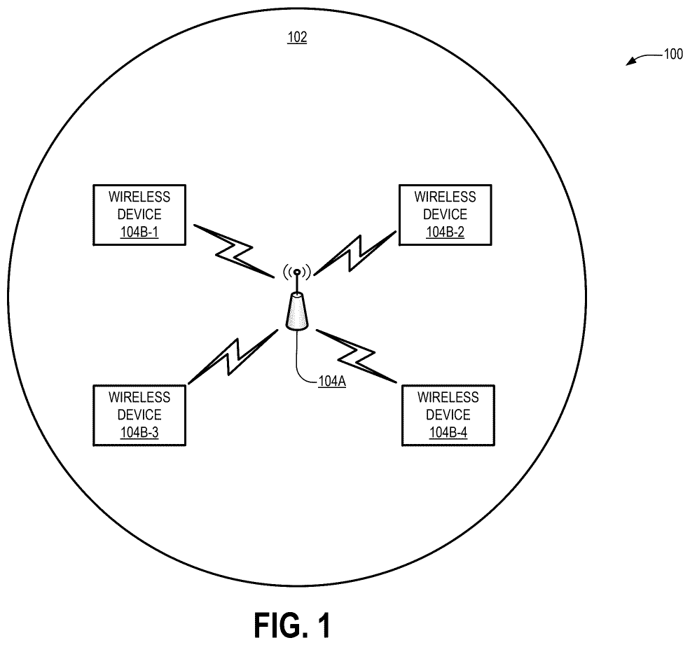

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

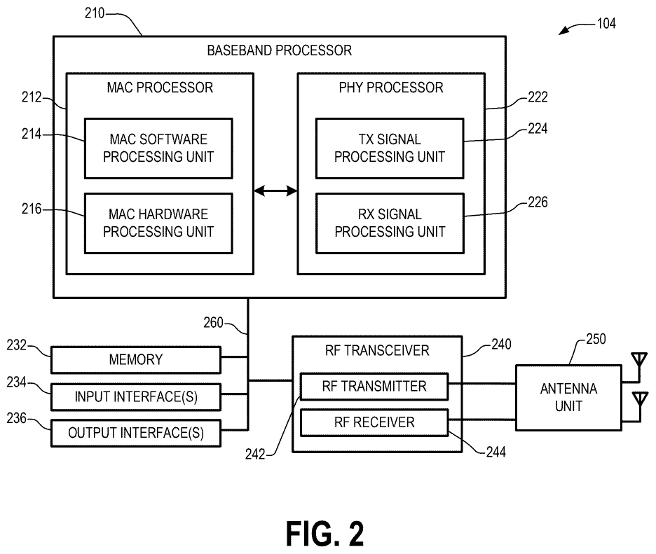

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

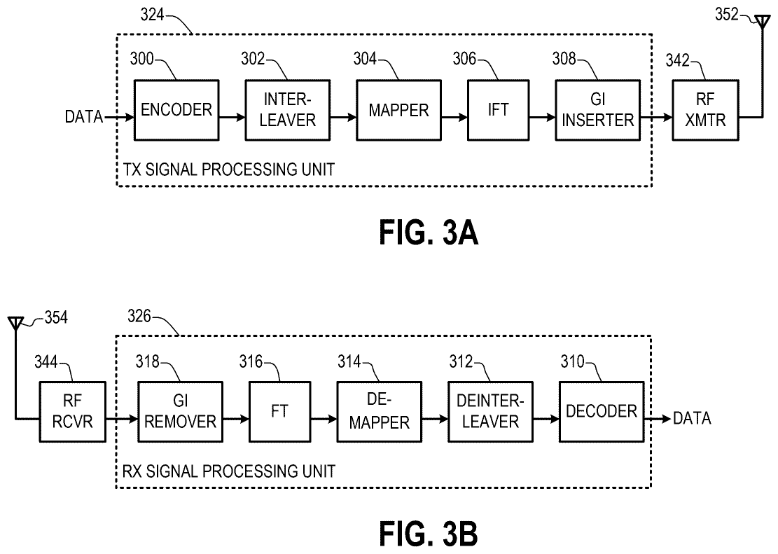

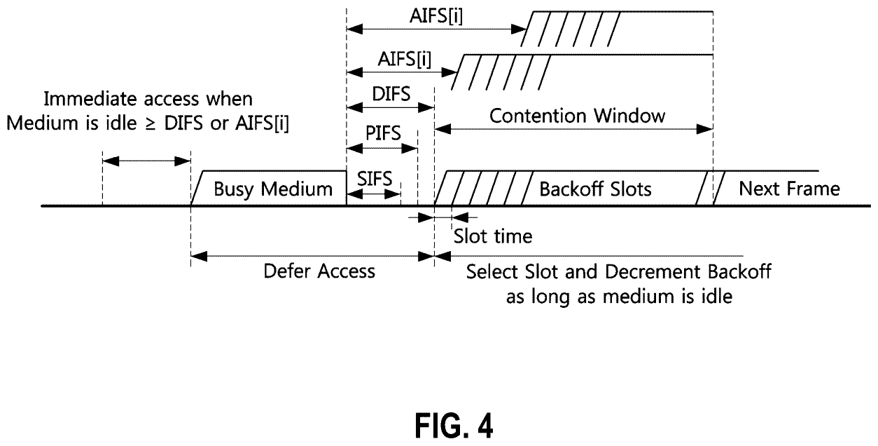

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

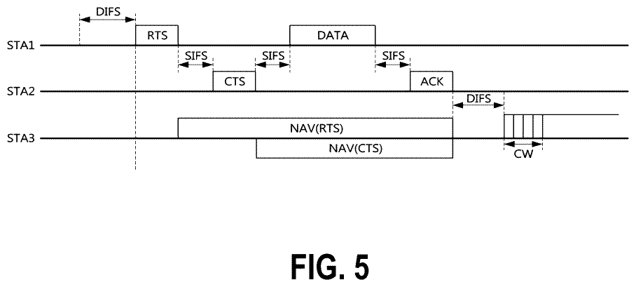

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

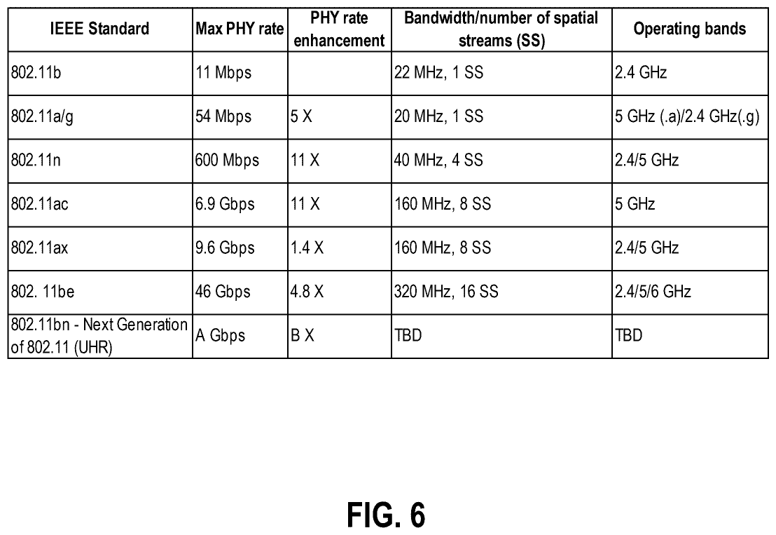

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

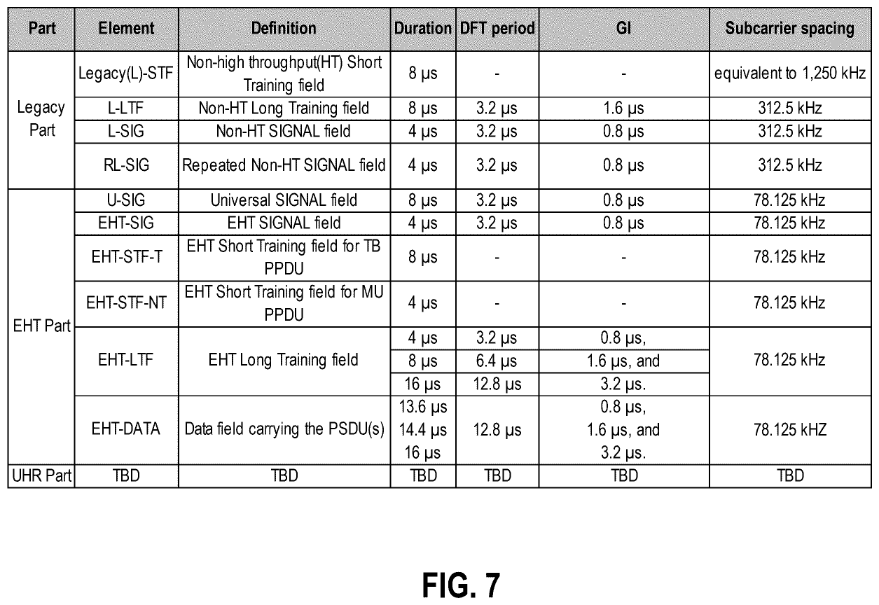

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

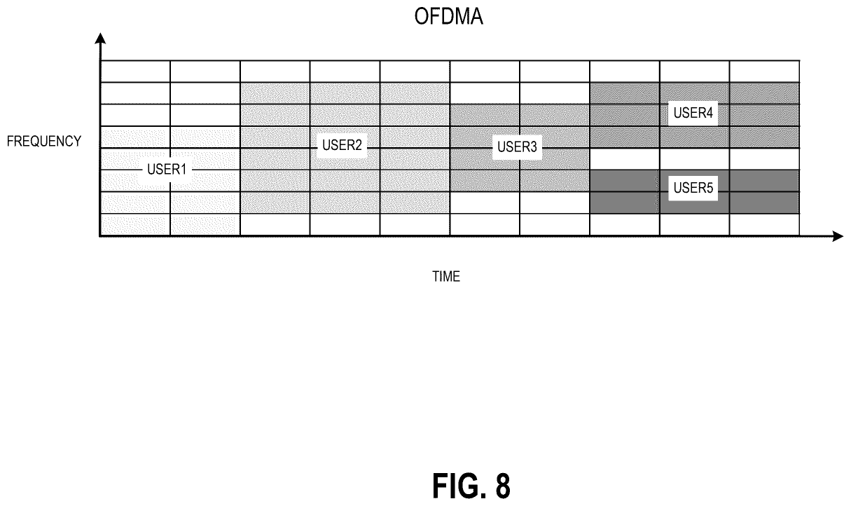

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

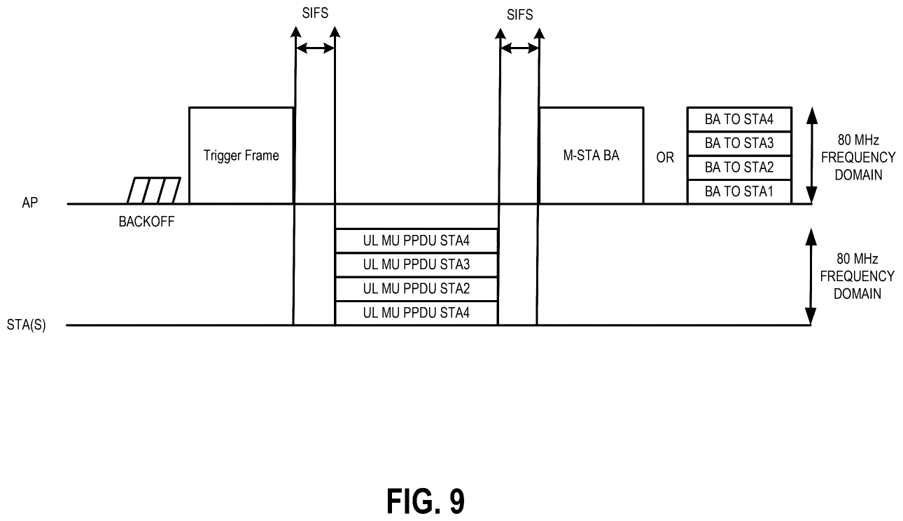

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

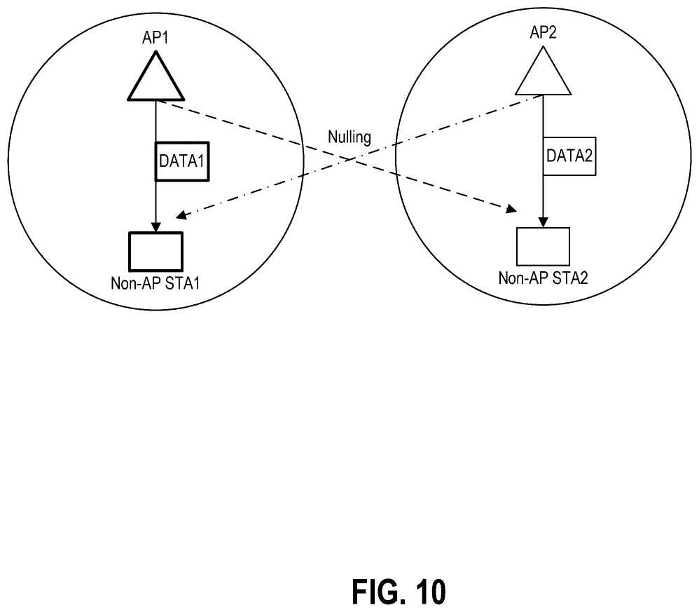

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Coordinated beamforming is a type of multi-AP coordination scheme where two or more APs may transmit data to their respective non-AP STAs while preemptively eliminating the potential interference that these data transmissions may cause to each other's non-AP STAs through nulling. The use of coordinated beamforming may increase the network throughput while minimizing interference.

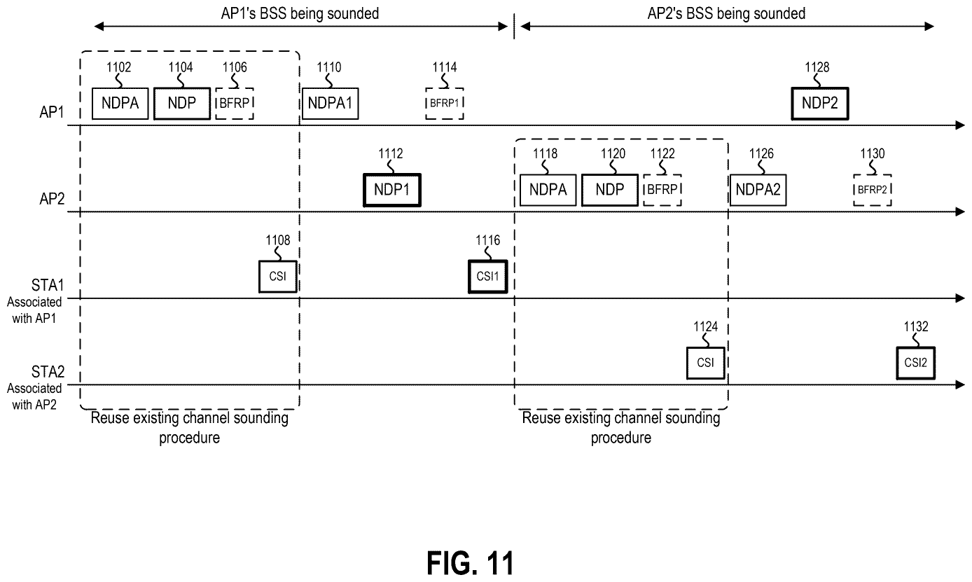

FIG. 10 is a diagram showing an example of coordinated beamforming being performed in a wireless network, according to some embodiments.

As shown in the diagram, the wireless network may include a first access point (AP1) operating a first BSS and a first non-AP STA (non-AP STA1) that is associated with AP1. Also, the wireless network may include a second AP (AP2) operating a second BSS and a second non-AP STA (non-AP STA2) that is associated with AP2.

AP1 and AP2 may cooperate with each other to perform coordinated beamforming. During coordinated beamforming, AP1 may transmit first data (DATA1) to non-AP STA1 and AP2 may transmit second data (DATA2) to non-AP STA2. AP1's transmission of DATA1 and AP2's transmission of DATA2 may be simultaneous. From the perspective of non-AP STA2, DATA1 may be received as interference. Also, from the perspective of non-AP STA1, DATA2 may be received as interference. That is, data transmitted by an OBSS AP to an OBSS non-AP STA can be perceived as interference (stronger than noise) from the perspective of a non-AP STA. Coordinated beamforming may use beamforming techniques to nullify such interference to allow the non-AP STAs to receive data from their respective APs without interference.

To perform effective coordinated beamforming, when AP1 transmits DATA1 to non-AP STA1, it must ensure that this transmission minimizes any impact on non-AP STA2's ability to receive DATA2 from AP2. One way to minimize the impact is for AP1 to apply a precoding technique at the digital stage when transmitting DATA1. By doing so, DATA1 can reach non-AP STA1 while ensuring that it does not reach non-AP STA2, thereby eliminating/reducing the interference that occurs at non-AP STA2. Such a process may be referred to as “nulling”. AP2 may also apply nulling when it transmits DATA2 to non-AP STA2 to eliminate/reduce the interference that occurs at non-AP STA1.

In coordinated beamforming, the main objective is to ensure that each AP can transmit data to its in-BSS STA while applying nulling towards OBSS STAs. For an AP to transmit data to in-BSS STAs while applying nulling towards OBSS STAs, the AP must obtain not only the channel state information for the links between the AP and its in-BSS STAs but also needs to obtain the channel state information for the links between the AP and OBSS STAs. For example, AP1 may need to obtain channel state information for the link between itself and non-AP STA2 and apply precoding/nulling towards non-AP STA2 to avoid causing interference at non-AP STA2. Similarly, AP2 may need to obtain channel state information for the link between itself and non-AP STA1 and apply precoding/nulling towards non-AP STA1 based on this channel state information to avoid causing interference at non-AP STA1.

It is assumed in this disclosure that APs can obtain channel state information for in-BSS links (links between an AP and its associated non-AP STAs) using an existing channel sounding procedure (e.g., in-BSS channel sounding procedure). Thus, the disclosure does not focus on the procedure for obtaining channel state information for in-BSS links. Instead, the disclosure primarily focuses on the procedure for obtaining channel state information for OBSS links (links between an AP and non-AP STAs that are associated with different AP(s)).

A channel sounding procedure that can be used to obtain channel state information for OBSS links is now described.

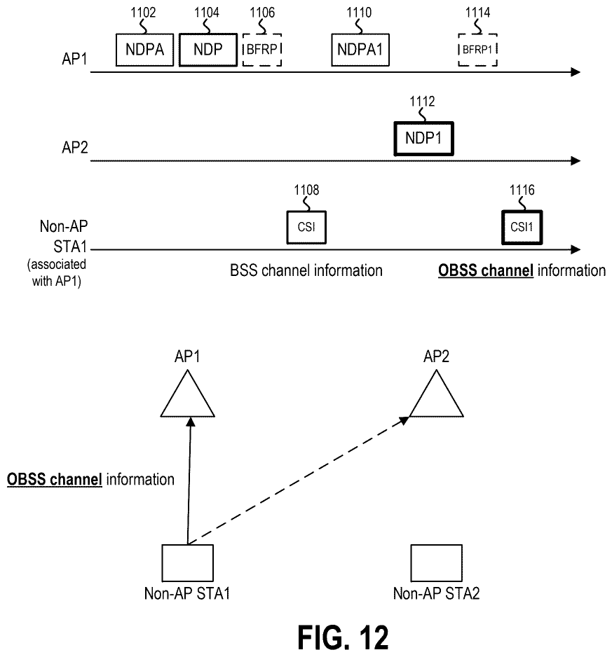

FIG. 11 is a diagram showing an OBSS channel sounding procedure, according to some embodiments.

In the example OBSS channel sounding procedure shown in the diagram, AP1's BSS is sounded first and then AP2's BSS is sounded. Channel sounding in AP1's BSS may involve the exchange of frames 1102-1116. Channel sounding in AP2's BSS may involve the exchange of frames 1118-1132.

As shown in the diagram, AP1 may transmit NDPA frame 1102 followed by NDP frame 1104. Responsive to receiving NDPA frame 1102 and NDP frame 1104, STA1 (which is associated with AP1) may generate channel state information for the link between itself and AP1 based on NDP frame 1104. AP1 may transmit BFRP frame 1106 to STA1 to solicit channel state information from STA1. Responsive to receiving BFRP frame 1106, STA1 may transmit channel state information feedback frame 1108, which may include the channel state information for the link between STA1 and AP1. Frames 1102-1108 shown in the diagram may follow an existing in-BSS channel sounding procedure.

AP1 may then transmit NDPA frame 1110 (“NDPA1”) to cause AP2 to transmit NDP frame 1112 (“NDP1”). Responsive to receiving NDPA1 1110, AP2 may transmit NDP1 1112. Responsive to receiving NDP1 1112, STA1 may generate channel state information for the link between itself and AP2 based on NDP1 1112. AP1 may then transmit BFRP frame 1114 (“BFRP1”) to solicit channel state information from STA1. Responsive to receiving BFRP1, STA1 may transmit channel state information feedback frame 1116 (“CSI1”), which may include the channel state information for the link between STA1 and AP2. CSI 1 1116 is meant to be overheard by AP2.

NDPA1 1110 is a NDPA frame transmitted by AP1. In a SU scenario, the TA (transmitter address) indicated in NDPA1 1110 is the address of AP1 and the RA (receiver address) indicated in NDPA1 1110 is the address of STA1 (the in-BSS STA). In a MU scenario, the TA is the address of AP1 and the RA is a broadcast address.

NDP1 1112 is a frame transmitted by AP2 (and not by AP1) after AP1 transmits NDPA1 1110. AP2 may be aware that the OBSS channel sounding procedure is being performed for purposes of performing coordinated beamforming with AP1. AP2 may become aware of this through a pre-negotiation process. Thus, AP2 may transmit NDP1 1112 upon receiving NDPA1 1110 from AP1. The TA/RA indicated in NDP1 1112 may be the same addresses indicated in NDPA1 1110. In this example, STA1 may consider NDPA1 1110 and NDP1 1112 as being transmitted by AP1 even though it is actually being transmitted by AP2.

For BFRP1 1114, the TA may be the same as the TA indicated in NDPA1 1110, while the RA may depend on the recipient of BFRP1 1114. According to the existing channel rules, if a single STA is being solicited, the RA may be the address of the single STA. However, if multiple STAs are being solicited, the RA may be a broadcast address. The purpose of BFRP1 1114 in this example is to solicit channel state information from STA1.

For CSI1 1116, the TA/RA may be swapped compared to the TA/RA indicated in NDPA1 1110. This is because CSI1 1116 is an action frame carrying compressed beamforming/CQI information, and action frames fall under the category of management frames in a broad sense. Consequently, CSI1 1116 may follow the existing format of management frames, which may be as follows: the RA indicated in CSI1 1116 is the TA indicated in NDPA1 1110 and the TA indicated in CSI1 is the address of STA1.

As a result of the exchange of frames 1110-1116, the channel state information for the link between STA1 and AP2 is fed back to AP1 via CSI1 1116. AP2 may overhear this feedback and thus obtain channel state information for the link between STA1 and itself. Consequently, when AP2 subsequently performs coordinated beamforming with AP1, it may calculate a precoding matrix based on the channel state information for the link between itself and STA1 to apply nulling towards STA1 when AP2 transmits data to an in-BSS STA such as STA2. This helps ensure that the transmission does not cause interference at STA1.

AP2's BSS may be sounded using a similar procedure. For example, AP2 may transmit NDPA frame 1118 followed by NDP frame 1120. Responsive to receiving NDPA frame 1118 and NDP frame 1120, STA2 (which is associated with AP2) may generate channel state information for the link between itself and AP2 based on NDP frame 1120. AP2 may transmit BFRP frame 1122 to STA2 to solicit channel state information from STA2. Responsive to receiving BFRP frame 1122, STA2 may transmit channel state information feedback frame 1124, which may include the channel state information for the link between STA2 and AP2. Frames 1118-1124 shown in the diagram may follow an existing in-BSS channel sounding procedure.

AP2 may then transmit NDPA frame 1126 (“NDPA2”) to cause AP1 to transmit NDP frame 1128 (“NDP2”). Responsive to receiving NDPA2 1126, AP1 may transmit NDP2 1128. Responsive to receiving NDP2 1128, STA2 may generate channel state information for the link between itself and AP1 based on NDP2 1128. AP2 may then transmit BFRP frame 1130 (“BFRP2”) to solicit channel state information from STA2. Responsive to receiving BFRP2, STA2 may transmit channel state information feedback frame 1132 (“CSI2”), which may include the channel state information for the link between STA2 and AP1. CSI2 1132 is meant to be overheard by AP1.

As a result of the exchange of frames 1126-1132, the channel state information for the link between STA2 and AP1 is fed back to AP2 via CSI2 1132. AP1 may overhear this feedback and thus obtain channel state information for the link between STA2 and itself. Consequently, when AP1 subsequently performs coordinated beamforming with AP2, it may calculate a precoding matrix based on the channel state information for the link between itself and STA2 to apply nulling towards STA2 when AP1 transmits data to an in-BSS STA such as STA1. This helps ensure that the transmission does not cause interference at STA2.

With the OBSS channel sounding procedure shown in the diagram, AP1 and AP2 may obtain channel state information that is needed for performing coordinated beamforming through two distinct operations.

The first operation is an in-BSS operation for obtaining channel state information for the link between itself and an in-BSS STA (e.g., using an existing in-BSS channel sounding procedure). For example, AP1 may obtain the channel state information for the link between itself and non-AP STA1 using an existing channel sounding procedure. Also, AP2 may obtain the channel state information for the link between itself and non-AP STA2 using an existing channel sounding procedure.

The second operation is an OBSS operation for obtaining channel state information for the link between itself and an OBSS STA. A first AP may transmit a NDPA frame and a second AP that is in coordination with the first AP may transmit a NDP frame in response to receiving the NDPA frame. Then, the first AP may solicit channel state information from an in-BSS STA with respect to the first AP. The channel state information fed back by the in-BSS STA may be overheard by the second AP (which is an OBSS AP with respect to the STA). The second AP may use this channel state information to apply nulling towards the in-BSS STA when performing coordinated beamforming.

For example, AP1 may transmit a NDPA frame, AP2 may transmit a NDP frame, AP1 may transmit a BFRP frame, and STA1 (associated with AP1) may transmit a channel state information feedback frame to AP1 that is meant to be overheard by AP2. The purpose of this procedure is to allow AP2 to overhear the channel information transmitted by STA1 to AP1, so that AP2 can apply nulling towards STA1 when transmitting data to STA2 (associated with AP2).

The same/similar procedure may apply in the other BSS. For example, AP2 may transmit a NDPA frame, AP1 may transmit a NDP frame, AP2 may transmit a BFRP frame, and STA2 (associated with AP2) may transmit a channel state information feedback frame to AP2 that is meant to be overheard by AP1. The purpose of this procedure is to allow AP1 to overhear the channel information transmitted by STA2 to AP2, so that AP1 can apply nulling towards STA2 when transmitting data to STA1 (associated with AP1).

By performing the two operations mentioned above (the in-BSS operation and OBSS operation), the APs may obtain the channel state information needed to transmit data to their respective in-BSS STAs while applying nulling towards OBSS STAs. However, for the second operation (OBSS operation) to be efficient, an AP must be able to reliably overhear the OBSS channel state information fed back by an OBSS STA without any loss. For example, AP2 needs to be able to reliably overhear the channel state information feedback frame transmitted by STA1 and AP1 needs to be able to reliably overhear the channel state information feedback frame transmitted by STA2.

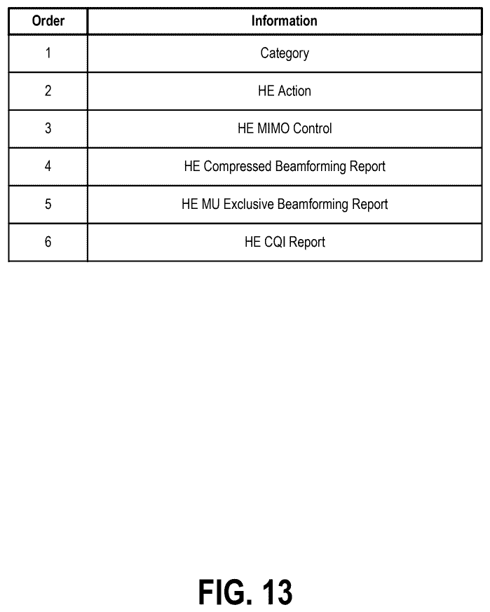

FIG. 12 is a diagram showing an example of feeding back OBSS channel information, according to some embodiments.

As shown in the diagram, AP1 may transmit NDPA frame 1102 and NDP frame 1104. Non-AP STA1 (which is associated with AP1) may generate channel state information for the link between itself and AP1 based on NDP frame 1104. This channel state information is referred to as “BSS channel information” because it is for an in-BSS link. AP1 may transmit BFRP frame 1106. Non-AP STA1 may then transmit channel state information feedback frame 1108 that includes the BSS channel information.

AP1 may then transmit NDPA1 1110 to cause AP2 to transmit NDP1 1112. Responsive to receiving/overhearing NDPA1 1110, AP2 may transmit NDP1 1112. Non-AP STA1 may generate channel state information for the link between itself and AP2 based on NDP1 1112. This channel state information is referred to as “OBSS channel state information” because it is for an OBSS link. AP2 may transmit BFRP1 1114. Non-AP STA1 may then transmit CSI1 1116 that includes the OBSS channel information.

In this example, OBSS channel information refers to the channel state information for the link between AP2 and non-AP STA1. However, AP2 cannot directly receive this information via a direct link. Instead, non-AP STA1 transmits the OBSS channel information to AP1, and AP2 must try to overhear this information (as depicted by the dashed arrow from non-AP STA1 to AP2).

Accordingly, there is a need to ensure that APs participating in an OBSS channel sounding procedure can reliably overhear and recognize OBSS channel state information. The present disclosure describes a technique that allows a STA to provide additional information to an OBSS AP that the OBSS AP can use to perform coordinated beamforming and/or channel sounding more efficiently. According to some embodiments, an existing field included in a channel state information feedback frame is repurposed to carry the additional information. In an embodiment, the existing field is a MU exclusive beamforming report field included in a compressed beamforming/CQI frame. The present disclosure describes various ways that the MU exclusive beamforming report field can be repurposed.

For context, a description is provided of how channel state information (also referred to as CSI) can be carried within frames and transmitted in existing IEEE 802.11 wireless networking standards. Channel state information can be carried in an action frame. Different versions/iterations of the IEEE 802.11 wireless networking standards may use different field formats to carry channel state information.

In IEEE 802.11ax (Wi-Fi 6), the action field of a HE compressed beamforming/CQI frame may be used to carry channel state information.

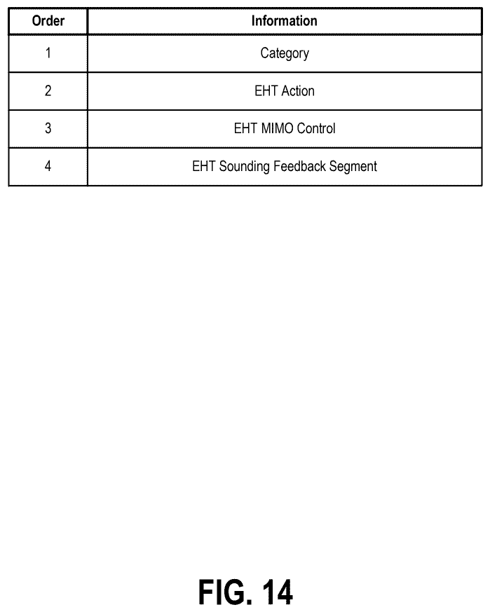

FIG. 13 is a diagram showing a HE compressed beamforming/CQI frame action field format, according to some embodiments.

As shown in the diagram the HE compressed beamforming/CQI frame may include category information, HE action information, HE MIMO control information, HE compressed beamforming report information, HE MU exclusive beamforming report information, and HE CQI report information. The various information mentioned above is defined in the IEEE 802.11 wireless networking standards and is not described in further detail herein for sake of brevity.

In IEEE 802.11be (Wi-Fi 7), the action field of an EHT compressed beamforming/CQI frame action field may be used to carry channel state information.

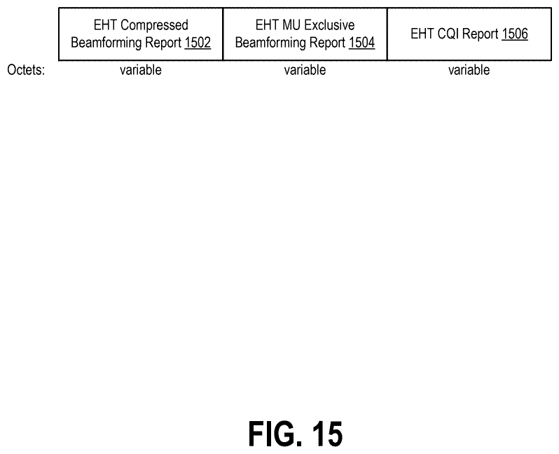

FIG. 14 is a diagram showing an EHT compressed beamforming/CQI frame action field format, according to some embodiments.

As shown in the diagram the EHT compressed beamforming/CQI frame may include category information, EHT action information, EHT MIMO control information, and EHT sounding feedback segment information. The various information mentioned above is defined in the IEEE 802.11 wireless networking standards and is not described in further detail herein for sake of brevity.

Also, the IEEE 802.11be wireless networking standard defines an EHT compressed beamforming/CQI report field to carry compressed beamforming report information, MU exclusive beamforming report information, and CQI report information.

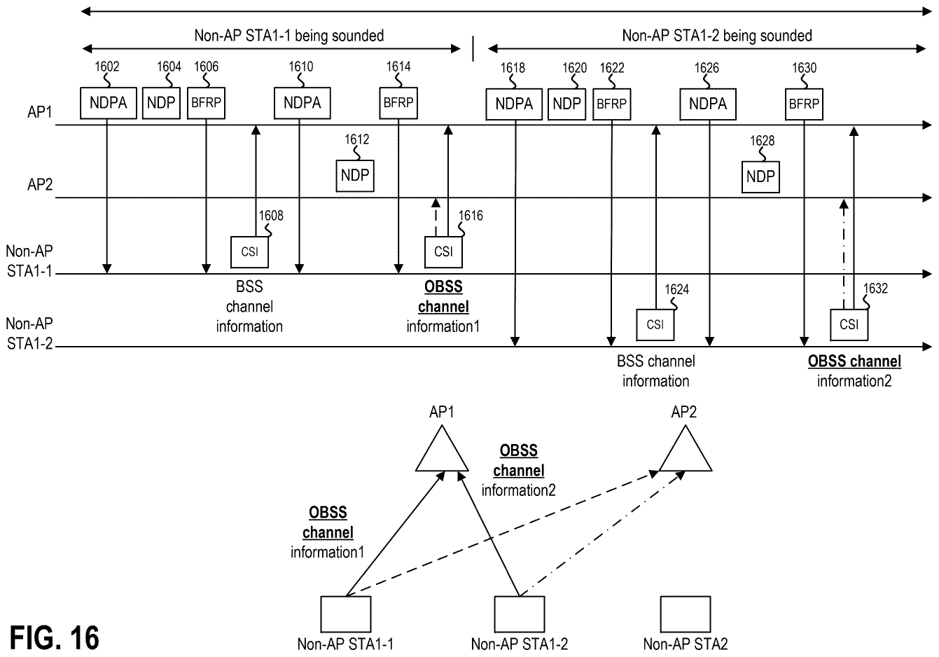

FIG. 15 is a diagram showing an EHT compressed beamforming/CQI report field format, according to some embodiments.

As shown in the diagram, the EHT compressed beamforming/CQI report field may include an EHT compressed beamforming report field 1502 (variable length), an EHT MU exclusive beamforming report field 1504 (variable length), and an EHT CQI report field 1506 (variable length). These fields may carry information similar to the HE compressed beamforming report information, the HE MU exclusive beamforming report information, and HE CQI report information defined in IEEE 802.11ax, respectively. The EHT compressed beamforming/CQI report field may be a subfield of the EHT sounding feedback segment field that carries EHT sounding feedback segment information.

In both the IEEE 802.11ax and IEEE 80211.be wireless networking standards, one or more of the following fields may be provided in a compressed beamforming/CQI report frame depending on the feedback type: compressed beamforming/CQI report field; MU exclusive beamforming report field, and CQI report field.

For SU (single-user) feedback, the compressed beamforming/CQI report field may be provided. For MU (multi-user) feedback, the compressed beamforming/CQI report field and the MU exclusive beamforming report field may be provided. For CQI feedback, the CQI report field may be provided.

Embodiments may leverage the MU exclusive beamforming report field to provide information to an OBSS AP that the OBSS AP can use to perform coordinated beamforming and/or channel sounding more efficiently.

For context, the purpose of the MU exclusive beamforming report field is now described. In existing IEEE 802.11 wireless networking standards, The MU exclusive beamforming report field is a mandatory report field in MU scenarios. This field enables feedback on the differentiation value of the space-time stream signal-to-noise ratio (SNR) for each subcarrier K. A STA that receives the MU exclusive beamforming report field may use the values provided therein to compute the precoding matrix (beamforming matrix) in MU scenarios.

This can be better understood by differentiating between SU and MU scenarios. In a SU scenario, the channel matrix can be transformed into an eigenchannel by applying singular value decomposition (SVD)-based precoding at both the transmitter and receiver. Even without the MU exclusive beamforming report field, the eigenchannel will have values close to one (1).

However, in an MU scenario, if the delta SNR values included in the MU exclusive beamforming report field are unknown, the channel cannot be transformed into an eigenchannel with a diagonal matrix of ones (1s), as in the SU scenario. Thus, for downlink (DL) MU-MIMO, where multiple in-BSS STAs are served simultaneously, it is important to know the delta SNR values for each space-time stream in advance to ensure that the channel appears identity matrix-like, minimizing interference between streams.

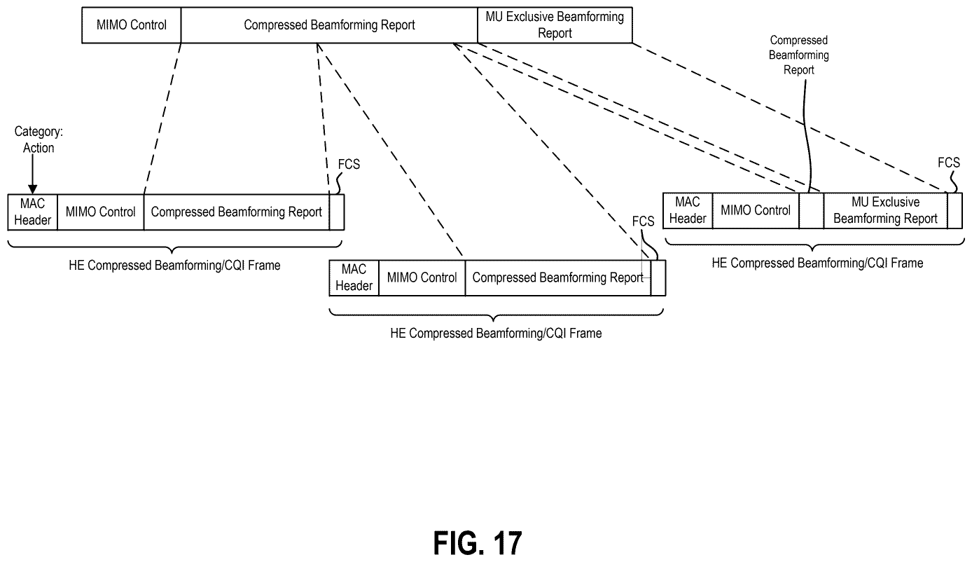

FIG. 16 is a diagram showing an OBSS channel sounding procedure in a MU scenario, according to some embodiments.

The OBSS channel sounding procedure shown in the diagram is for sounding AP1's BSS. It should be appreciated that a similar procedure can be followed to sound AP2's BSS.

AP1's BSS may include non-AP STA1-1 and non-AP STA1-2. The OBSS channel sounding procedure may include a first portion that is for sounding non-AP STA1-1 and a second portion that is for sounding non-AP STA1-2. The OBSS sounding procedure may allow AP2 (which is an OBSS AP from the perspective of non-AP STA1-1 and non-AP STA1-2) to obtain channel state information for the link between itself and non-AP STA1-1 and the link between itself and non-AP STA1-2.

As shown in the diagram, AP1 may transmit NDPA frame 1602 followed by NDP frame 1604. Responsive to receiving NDPA frame 1602 and NDP frame 1604, STA1-1 may generate channel state information for the link between itself and AP1 based on NDP frame 1604. AP1 may transmit BFRP frame 1606 to STA1-1 to solicit channel state information from STA1-1. Responsive to receiving BFRP frame 1606, STA1-1 may transmit channel state information feedback frame 1608, which may include the channel state information for the link between STA1-1 and AP1 (“BSS channel information”).

AP1 may then transmit NDPA frame 1610 to cause AP2 to transmit NDP frame 1612. Responsive to receiving NDPA frame 1610, AP2 may transmit NDP frame 1612. Responsive to receiving NDP frame 1612, STA1-1 may generate channel state information for the link between itself and AP2 based on NDP frame 1612. AP1 may then transmit BFRP frame 1614 to solicit channel state information from STA1-1. Responsive to receiving BFRP frame 1614, STA1-1 may transmit channel state information feedback frame 1616, which may include the channel state information for the link between STA1-1 and AP2 (“OBSS channel information1”). Channel state information feedback frame 1616 is meant to be overheard by AP2, as depicted by the dashed arrow from non-AP STA1-1 to AP2.

Also, as shown in the diagram, AP2 may transmit NDPA frame 1618 followed by NDP frame 1620. Responsive to receiving NDPA frame 1618 and NDP frame 1620, STA1-2 may generate channel state information for the link between itself and AP1 based on NDP frame 1620. AP1 may transmit BFRP frame 1622 to STA1-2 to solicit channel state information from STA1-2. Responsive to receiving BFRP frame 1622, STA1-2 may transmit channel state information feedback frame 1624, which may include the channel state information for the link between STA1-2 and AP1 (“BSS channel information”).

AP2 may then transmit NDPA frame 1626 to cause AP2 to transmit NDP frame 1628. Responsive to receiving NDPA frame 1626, AP2 may transmit NDP frame 1628. Responsive to receiving NDP frame 1628, STA1-2 may generate channel state information for the link between itself and AP2 based on NDP frame 1628. AP1 may then transmit BFRP frame 1630 to solicit channel state information from STA1-2. Responsive to receiving BFRP frame 1630, STA1-2 may transmit channel state information feedback frame 1632, which may include the channel state information for the link between STA1-2 and AP2 (“OBSS channel information2”). Channel state information feedback frame 1632 is meant to be overheard by AP2, as depicted by the dashed dotted arrow from non-AP STA1-2 to AP2.

Thus, the OBSS channel sounding procedure may allow AP2 to obtain OBSS channel information1 and OBSS channel information2. During coordinated beamforming, AP2 may transmit data to its in-BSS STAs (e.g., non-AP STA2) while applying nulling towards non-AP STA1-1 using OBSS channel information1 and applying nulling towards non-AP STA1-2 using OBSS channel information2 to eliminate/reduce interference at non-AP STA1-1 and non-AP STA1-2.

It is assumed that the scenario shown in the diagram is a MU scenario. Thus, according to existing IEEE 802.11 wireless networking standards, channel state information feedback frame 1616 and channel state information feedback frame 1632 must include a compressed beamforming/CQI report field and a MU exclusive beamforming report field. The MU exclusive beamforming report field may carry the SNR differentiation information for space-time streams within AP1's BSS.

However, from AP2's perspective, the MU exclusive beamforming report field transmitted by non-AP STA1-1 and non-AP STA1-2 is unnecessary in a MU scenario because AP2 only needs to perform nulling for OBSS STAs (e.g., non-AP STA1-1 and non-AP STA1-2) during coordinated beamforming. The MU exclusive beamforming report field is only relevant for AP1 and is irrelevant from AP2's perspective. Also, from AP1's perspective the MU exclusive beamforming report field included in channel state information feedback frame 1616 and channel state information feedback frame 1632 is redundant because AP1 can obtain the MU exclusive beamforming report information from channel state information feedback frame 1608 and/or channel state information feedback frame 1624.

Based on this recognition, embodiments repurpose the MU exclusive beamforming report field to carry information other than MU exclusive beamforming report information, since the MU exclusive beamforming report information may be unnecessary/redundant (e.g., in a MU coordinated beamforming scenario).

As mentioned earlier, nulling can be applied during coordinated beamforming to mitigate interference towards OBSS STAs. To apply nulling, an AP may need to overhear the channel state information feedback frames transmitted by OBSS STA(s). However, the AP might not be able to reliably overhear frames transmitted by OBSS STA(s). For example, if non-AP STA1-1 transmits OBSS channel information1 to AP1, and AP2 attempts to overhear it, poor link quality may prevent successful overhearing. If AP2 fails to overhear OBSS channel information1, the nulling applied by AP2 towards non-AP STA1-1 may be unsuccessful or ineffective, thereby degrading the coordinated beamforming performance. As will be described in additional detail herein, the MU exclusive beamforming report field can be repurposed to carry information that can help enhance coordinated beamforming and/or channel sounding. By way of example, five ways of repurposing the MU exclusive beamforming report field are described herein. It should be appreciated that the MU exclusive beamforming report field can be repurposed in other ways to enhance coordinated beamforming and/or channel sounding.

### Repurposing Method 1

In an embodiment, OBSS channel information can be transmitted using a low modulation coding scheme (MCS) to improve reception reliability. The drawback of doing this is that the use of a lower MCS increases the transmission duration. To mitigate this, some of the feedback information can be included in the MU exclusive beamforming report field to reduce the transmission duration. For example, non-AP STA1-1 may transmit channel state information feedback frame 1616 using a MCS that is one step lower than the MCS indicated in the BFRP frame that solicits the channel state information (e.g., BFRP frame 1614) and repurpose the MU exclusive beamforming report field included in channel state information feedback frame 1616 to carry information other than MU exclusive beamforming report information such as other types of channel-sounding-related information that is needed to perform coordinated beamforming. As mentioned above, a channel state information feedback frame may include a compressed beamforming report field immediately followed by a MU exclusive beamforming report field. In coordinated beamforming scenarios, the MU exclusive beamforming report field (which might not be relevant for coordinated beamforming scenarios) can be repurposed to carry other type of channel state information (e.g., compressed beamforming report information), which may allow the channel state information to be transmitted in fewer PPDUs (e.g., transmitted in a single PPDU instead of two separate PPDUs, each having its own PHY header), which can reduce the overall transmission duration/overhead.

### Repurposing Method 2

In the scenario where channel state information is large, the channel state information may not fit within a single channel state information feedback frame so the channel state information may need to be transmitted over multiple channel state information feedback frames. In an embodiment, the MU exclusive beamforming report field can be repurposed to carry any information that does no The MU exclusive beamforming report field may not be necessary from the perspective of AP2. However, by repurposing this field, the CSI information can be transmitted immediately after the compressed beamforming report field, without the need to transmit it in two separate PPDUs, each with its own PHY header.

In short, considering the property that the MU exclusive beamforming report field can be transmitted contiguously following the compressed beamforming report field, the intention is to repurpose the MU exclusive beamforming report field, which may not be used for Co-BF.

t fit in the primary channel state information feedback frame.

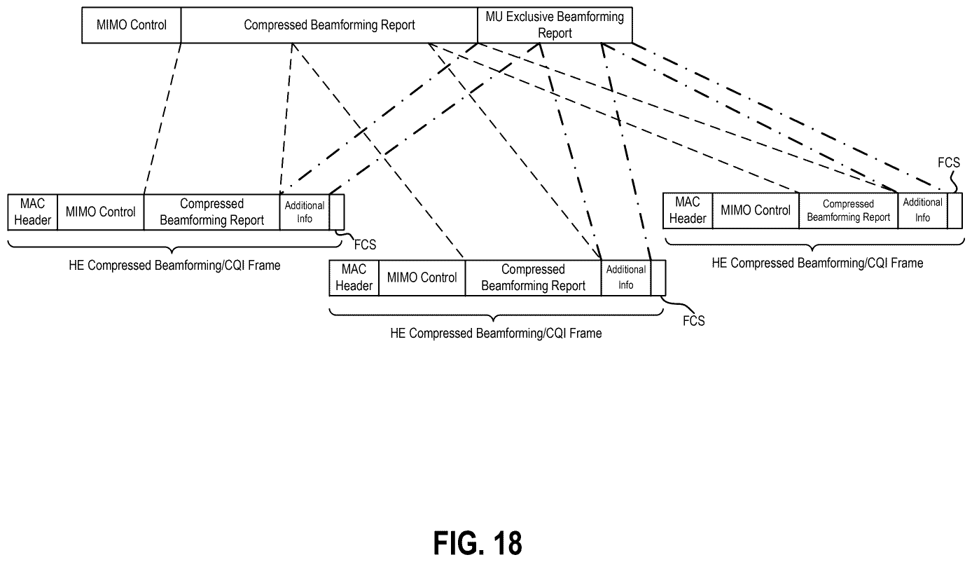

FIG. 17 is a diagram showing an example of how channel state information is transmitted when the MU exclusive beamforming report field is not repurposed, according to some embodiments.

The channel state information may include MIMO control information, compressed beamforming report information, and MU exclusive beamforming report information. In the example shown in the diagram, it is assumed that the channel state information is too large to fit in a single HE compressed beamforming/CQI frame so the information is transmitted across three HE compressed beamforming/CQI frames. As shown in the diagram, the first HE compressed beamforming/CQI frame may include a MAC header, a MIMO control field, a first portion of the compressed beamforming report information, and a frame check sequence (FCS) field. The MAC header may include an indication that the frame is an action frame. The second HE compressed beamforming/CQI frame may include a MAC header, a MIMO control field, a second portion of the compressed beamforming report information, and a FCS field. The third HE compressed beamforming/CQI frame may include a MAC header, a MIMO control field, a third/final portion of the compressed beamforming report information, the MU exclusive beamforming report information, and a FCS field. Each HE compressed beamforming/CQI frame may include its own MIMO control field to carry information indicating which segment of the channel state information is being provided in the frame and how many segments remain.

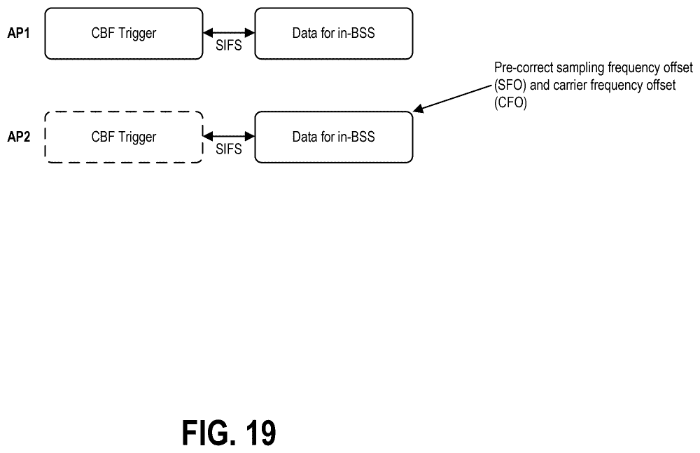

FIG. 18 is a diagram showing an example of repurposing the MU exclusive beamforming report field, according to some embodiments.

As shown in the diagram, a first HE compressed beamforming/CQI frame may include a MAC header, a MIMO control field, a first portion of the compressed beamforming report information, additional information, and a FCS field. The second HE compressed beamforming/CQI frame may include a MAC header, a MIMO control field, a second portion of the compressed beamforming report information, additional information, and a FCS field. The third HE compressed beamforming/CQI frame may include a MAC header, a MIMO control field, a third/final portion of the compressed beamforming report information, additional information, and a FCS field. The additional information can be carried in the MU exclusive beamforming report fields of the frames in lieu of MU exclusive beamforming report information. If any of the additional information is associated with the compressed beamforming report information included in a particular frame/segment, the additional information may be included in that frame/segment. The example shown in the diagram assumed that this is the case so the additional information is shown as being spread across the three frames/segments. For example, if the compressed beamforming report information is assumed to be 1, 2, 3, 4, 5, 6 and the additional information is a, b, c, d, e, f, and if the information is correlated such that {(1,2) is associated with (a,b)}, {(3,4) is associated with (c,d)}, and {(5,6) is associated with (e,f)}, and meaningful information can be obtained only when they are decoded together, then it may be beneficial to divide the transmission into three frames and distribute the additional information accordingly (e.g., so that the additional information is grouped together with its associated compressed beamforming report information).

In an embodiment, when repurposing the MU exclusive beamforming report field, some of the channel state information that would normally be carried in a field other than the MU exclusive beamforming report field (e.g., compressed beamforming report information) may be carried in the MU exclusive beamforming report field, which reduces overhead. Repurposing the MU exclusive beamforming report field may allow additional information to be conveyed without increasing the number of frames.

### Repurposing Method 3

The non-AP STA may repurpose the MU exclusive beamforming report field to carry additional information that can be helpful for an upcoming coordinated beamforming operation. For example, if non-AP STA1-1 and non-AP STA1-2 did not properly receive data from AP1 during a previous coordinated beamforming performed by AP1 and AP2, this might mean that AP2 did not apply nulling correctly. In such case, during a subsequent OBSS channel sounding procedure, non-AP STA1 and/or non-AP STA1-2 may repurpose the MU exclusive beamforming report field to indicate that nulling was not successfully applied during the previous coordinated beamforming operation. Responsive to overhearing this indication, AP2 may decide to apply nulling differently during the next coordinated beamforming performed with AP1 (i.e., not apply nulling in the same way as before).

Even if nulling was applied correctly at the digital layer, interference may occur at non-AP STA2 if AP2's transmit power is too high. In this case, the MU exclusive beamforming report field may be repurposed to indicate that nulling was not successfully applied. Additionally or alternatively, the MU exclusive beamforming report field may be repurposed to include the received signal strength indicator (RSSI) information for the NDP frame transmitted by AP2. AP2 may use this information to perform power control based on the RSSI when performing coordinated beamforming to reduce the interference at non-AP STA 1-2.

The information that can be carried in the MU exclusive beamforming report field in Repurposing method 3 can be based on conditions. In the case of Repurposing methods 2 and 3 described above, the MU exclusive beamforming report field can be efficiently repurposed when there is enough space in the MU exclusive beamforming report field to carry the relevant information. The amount of space available in the MU exclusive beamforming report field depends on the Nc value included in the MIMO control field. In particular, the amount of space increases when the Nc value (space-time stream) is larger. That is, the length of the MU exclusive beamforming report field can vary depending on the Nc value included in the MIMO control field.

As an example, consider a scenario where the Nc value included in the MIMO control field is large and the quantization of channel feedback is increased to receive high-resolution feedback. In such case, the amount of space in the MU exclusive report field that can be repurposed increases due to the large Nc value. Also, since channel state information feedback is solicited with high resolution, the amount of information that can be fed back also increases. That is, since there is a large amount of information to be fed back and the amount of space in the MU exclusive beamforming report field is also large, it is possible to efficiently perform feedback by including the remaining information in the MU exclusive beamforming report field of a single channel state information feedback frame.

### Repurposing Method 4

The MU exclusive beamforming report field may be repurposed to include carrier frequency offset (CFO) and/or sampling frequency offset (SFO) information of the NDPA frame and NDP frame. In the channel sounding procedure shown in FIG. 16, non-AP STA1-1 is sounded first and then non-AP STA1-2 is sounded afterwards. AP1 may transmit NDPA frame 1610 and AP2 may transmits NDP frame 1612 after a predefined interframe space (IFS) interval (e.g., short interframe space (SIFS) interval) to allow non-AP STA1-1 to generate channel state information for the link between non-AP STA 1-1 and AP2. However, having different devices transmit frames at specific IFS intervals (e.g., SIFS interval) can cause synchronization issues, especially when different oscillators are used in each device.

As an example, when non-AP STA1-1 transmits channel state information feedback frame 1616 that includes OBSS channel information1, the CFO/SFO values of the NDPA frame 1610 transmitted by AP1 and the NDP frame 1612 transmitted by AP2 may be included in the MU exclusive beamforming report field. AP2 may synchronize its timing with AP1 based on the CFO/SFO values so that AP2 may transmit NDP frame 1628 after AP1 transmits NDPA frame 1626 (for sounding non-AP STA1-2) using the synchronized timing. The synchronized timing can also be applied during coordinated beamforming that is performed after the OBSS sounding procedure has been completed. For example, after the OBSS sounding procedure has been completed, AP2 may transmit a data frame to its in-BSS STA after an IFS interval after receiving a coordinated beamforming triggering frame from AP1 using the synchronized timing.

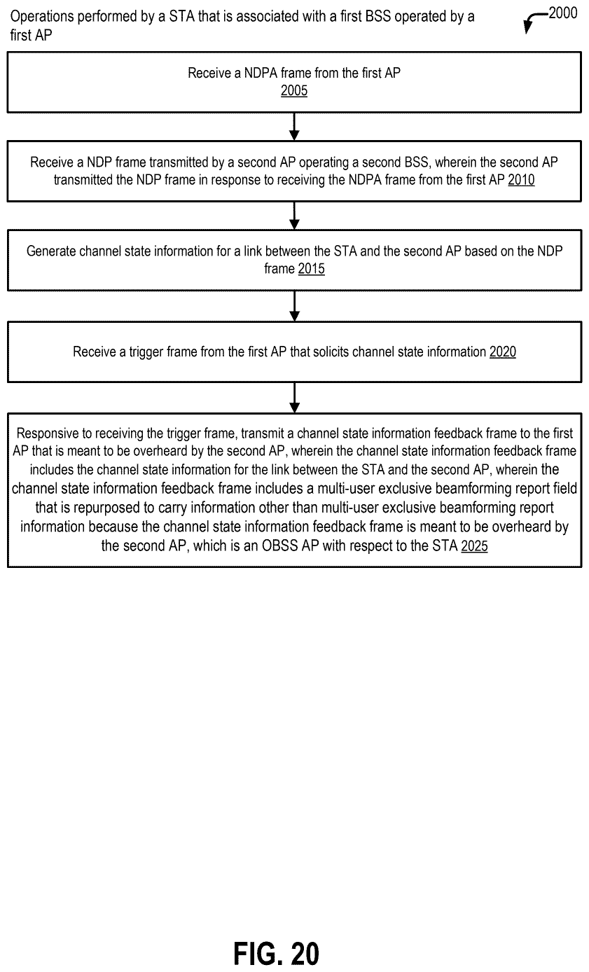

FIG. 19 is a diagram showing an example of using synchronized timing to transmit data during coordinated beamforming, according to some embodiments.

As shown in the diagram, during coordinated beamforming, AP1 may transmit a coordinated beamforming trigger frame to AP2 to cause AP2 to transmit data. AP1 may transmit data to its in-BSS STA(s) after a SIFS interval after transmitting the coordinated beamforming trigger frame. Also, AP2 may transmit data to its in-BSS STA(s) after a SIFS interval after receiving the coordinated beamforming trigger frame. AP2 may synchronize its timing with AP1 based on SFO/CFO information that AP2 previously overheard from a repurposed MU exclusive beamforming report field. This ensures that AP1 and AP2 transmit data in a synchronized manner during coordinated beamforming.

### Repurposing Method 5

The MU exclusive beamforming report field may be repurposed to carry phase difference information and/or phase noise information of a NDPA frame transmitted by one AP and a NDP frame transmitted by another AP. For example, the MU exclusive beamforming report field included in channel state information feedback frame 1616 may be repurposed to carry phase difference information and/or phase noise information of NDPA frame 1610 transmitted by AP1 and NDP frame 1612 transmitted by AP2. After the OBSS channel sounding procedure is complete, the AP1 and AP2 may perform coordinated beamforming by transmitting data to their respective in-BSS STAs. If the frames transmitted by AP1 and AP2 for their respective in-BSS STAs have a significant phase difference, non-AP STA1 (associated with AP1) may fail to receive the frame transmitted by AP1, and non-AP STA2 (associated with AP2) may also fail to receive the frame transmitted by AP2. Furthermore, if the lengths of the frames transmitted to in-BSS STAs are aligned during coordinated beamforming, and the phase difference is 180 degrees, the two transmissions could completely overlap and be received as a zero signal. To preemptively address this issue, phase-related information can be included in the MU exclusive beamforming report field.

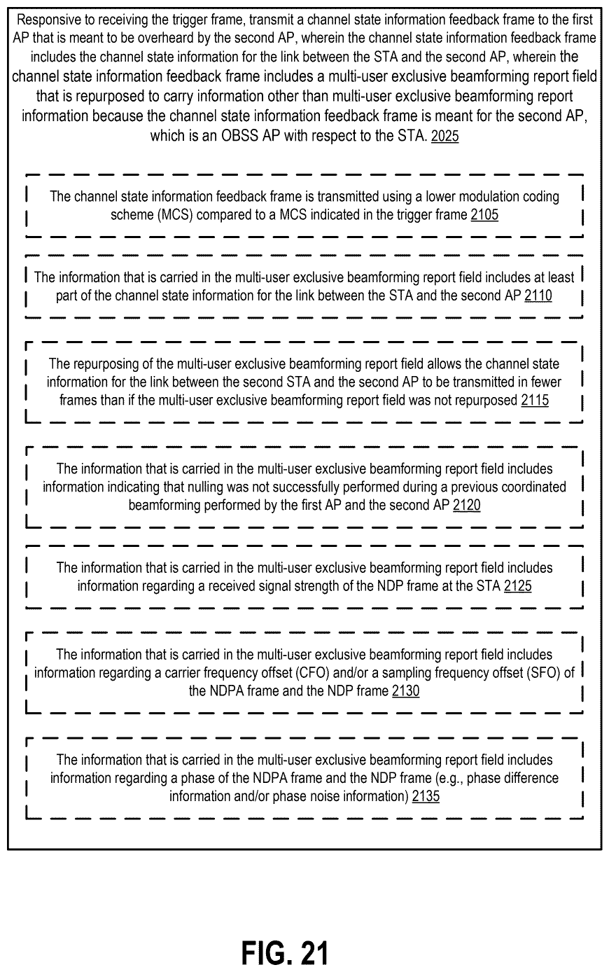

Turning now to FIG. 20, a method 2000 will be described for participating in an OBSS channel sounding procedure, in accordance with an example embodiment. The method 2000 may be performed by a STA that is associated with a first AP operating a first BSS. The STA may be implemented by a wireless device (e.g., wireless device 104).

Additionally, although shown in a particular order, in some embodiments the operations of the method 2000 (and the other methods shown in the other figures) may be performed in a different order. For example, although the operations of the method 2000 are shown in a sequential order, some of the operations may be performed in partially or entirely overlapping time periods.

At operation 2005, the STA receives a NDPA frame from the first AP.

At operation 2010, the STA receives a NDP frame transmitted by a second AP operating a second BSS, wherein the second AP transmitted the NDP frame in response to receiving the NDPA frame from the first AP.

At operation 2015, the STA generates channel state information for a link between the STA and the second AP based on the NDP frame.

At operation 2020, the STA receives a trigger frame from the first AP that solicits channel state information.

At operation 2025, responsive to receiving the trigger frame, the STA transmits a channel state information feedback frame to the first AP that is meant to be overheard by the second AP, wherein the channel state information feedback frame includes the channel state information for the link between the STA and the second AP, wherein the channel state information feedback frame includes a multi-user exclusive beamforming report field that is repurposed to carry information other than multi-user exclusive beamforming report information because the channel state information feedback frame is meant to be overheard by the second AP, which is an OBSS AP with respect to the STA.

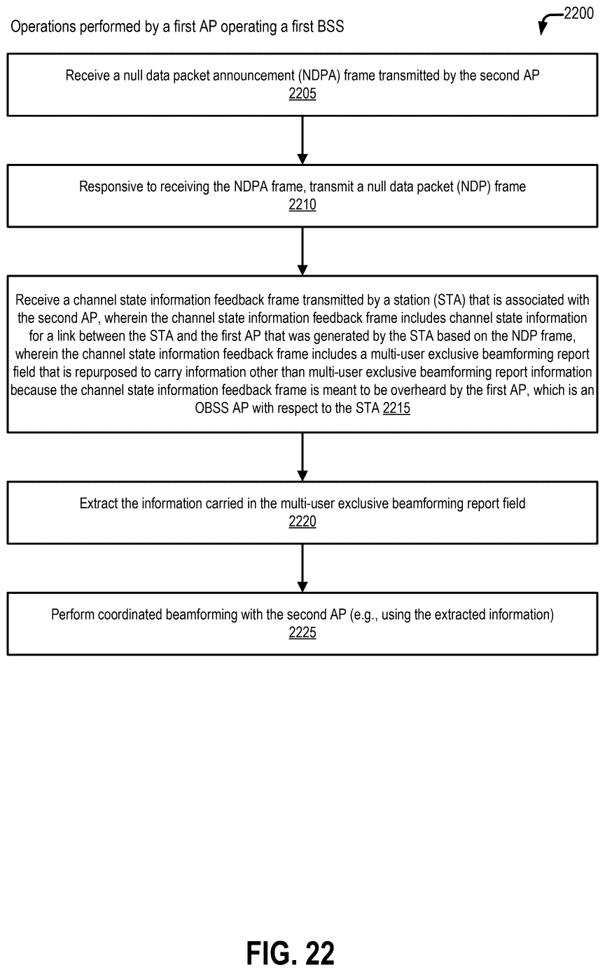

FIG. 21 is a diagram showing examples of information that can be included in a multi-user exclusive beamforming report field, according to some embodiments.

Blocks 2105-2135 shown in the diagram describe further details of operation 2025.

In an embodiment, as shown in block 2105, the channel state information feedback frame is transmitted using a lower modulation coding scheme (MCS) compared to a MCS indicated in the trigger frame.

In an embodiment, as shown in block 2110, the information that is carried in the multi-user exclusive beamforming report field includes at least part of the channel state information for the link between the STA and the second AP.

In an embodiment, as shown in block 2115, the repurposing of the multi-user exclusive beamforming report field allows the channel state information for the link between the second STA and the second AP to be transmitted in fewer frames than if the multi-user exclusive beamforming report field was not repurposed.

In an embodiment, as shown in block 2120, the information that is carried in the multi-user exclusive beamforming report field includes information indicating that nulling was not successfully performed during a previous coordinated beamforming performed by the first AP and the second AP.

In an embodiment, as shown in block 2125, the information that is carried in the multi-user exclusive beamforming report field includes information regarding a received signal strength of the NDP frame at the STA.

In an embodiment, as shown in block 2130, the information that is carried in the multi-user exclusive beamforming report field includes information regarding a carrier frequency offset (CFO) and/or a sampling frequency offset (SFO) of the NDPA frame and the NDP frame.

In an embodiment, as shown in block 2135, the information that is carried in the multi-user exclusive beamforming report field includes information regarding a phase of the NDPA frame and the NDP frame (e.g., phase difference information and/or phase noise information).

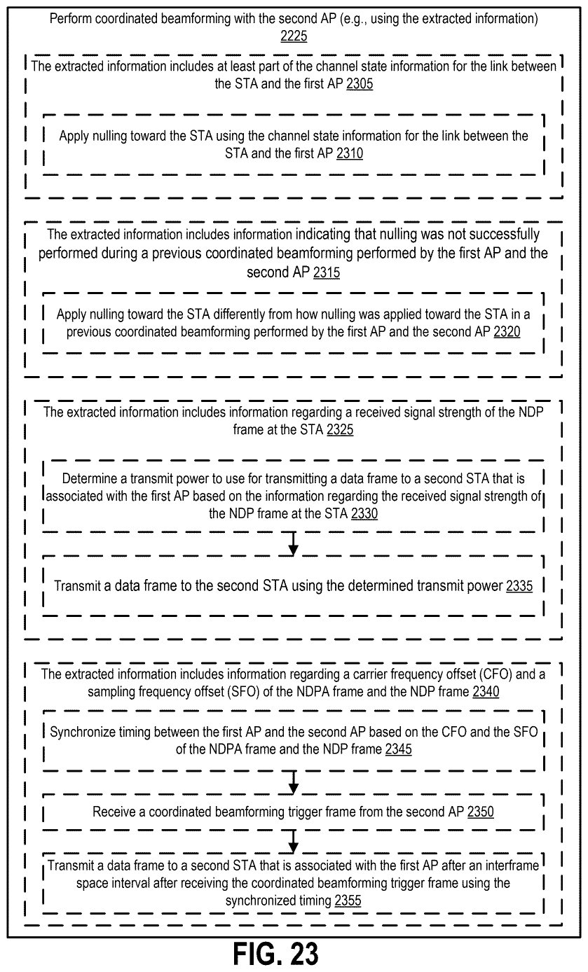

Turning now to FIG. 22, a method 2200 will be described for performing an OBSS channel sounding procedure, in accordance with an example embodiment. The method 2200 may be performed by a first AP operating a first BSS. The first AP may be implemented by a wireless device (e.g., wireless device 104).

At operation 2205, the first AP receives a null data packet announcement (NDPA) frame transmitted by the second AP.

At operation 2210, responsive to receiving the NDPA frame, the first AP transmits a null data packet (NDP) frame.

At operation 2215, the first AP receives a channel state information feedback frame transmitted by a station (STA) that is associated with the second AP, wherein the channel state information feedback frame includes channel state information for a link between the STA and the first AP that was generated by the STA based on the NDP frame, wherein the channel state information feedback frame includes a multi-user exclusive beamforming report field that is repurposed to carry information other than multi-user exclusive beamforming report information because the channel state information feedback frame is meant to be overheard by the first AP, which is an OBSS AP with respect to the STA.

At operation 2220, the first AP extracts the information carried in the multi-user exclusive beamforming report field.

At operation 2225, the first AP performs coordinated beamforming with the second AP (e.g., using the extracted information).

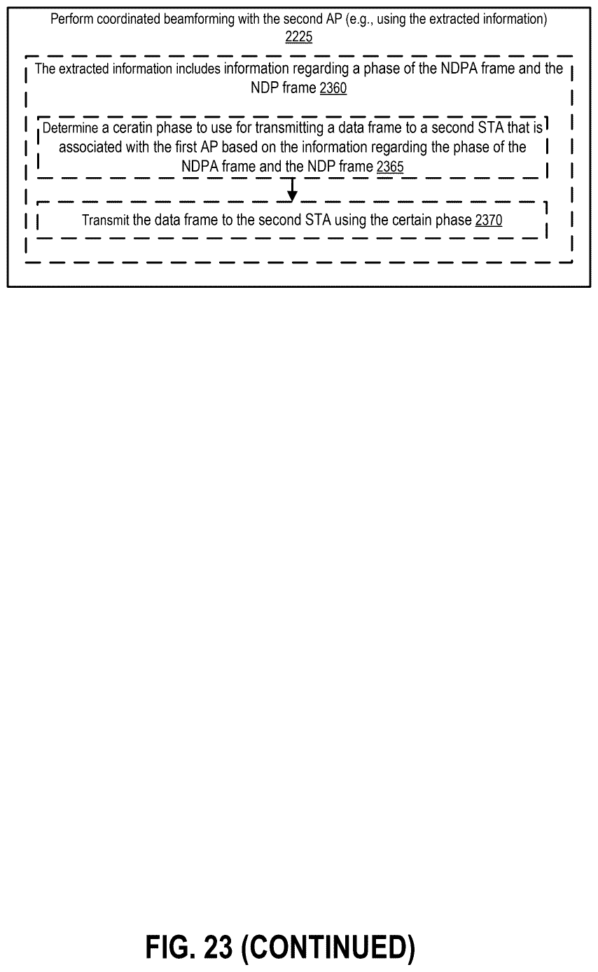

FIG. 23 is a diagram showing examples of how information extracted from a multi-user exclusive beamforming report field can be used, according to some embodiments.

Blocks 2305-2355 shown in the diagram describe further details of operation 2225.

In an embodiment, as shown in block 2305, the extracted information includes at least part of the channel state information for the link between the STA and the first AP. In this case, as shown in block 2310, the first AP may apply nulling toward the STA using the channel state information for the link between the STA and the first AP.

In an embodiment, as shown in block 2315, the extracted information includes information indicating that nulling was not successfully performed during a previous coordinated beamforming performed by the first AP and the second AP. In this case, as shown in block 2320, the first AP may apply nulling toward the STA differently from how nulling was applied toward the STA in a previous coordinated beamforming performed by the first AP and the second AP.

In an embodiment, as shown in block 2325, the extracted information includes information regarding a received signal strength of the NDP frame at the STA. In this case, as shown in block 2330 and block 2335, respectively, the first AP may determine a transmit power to use for transmitting a data frame to a second STA that is associated with the first AP based on the information regarding the received signal strength of the NDP frame at the STA and transmit a data frame to the second STA using the determined transmit power.

In an embodiment, as shown in block 2340, the extracted information includes information regarding a carrier frequency offset (CFO) and a sampling frequency offset (SFO) of the NDPA frame and the NDP frame. In this case, as shown in block 2345, block 2350, and block 2355, respectively, the first AP may synchronize timing between the first AP and the second AP based on the CFO and the SFO of the NDPA frame and the NDP frame, receive a coordinated beamforming trigger frame from the second AP, and transmit a data frame to a second STA that is associated with the first AP after an interframe space interval after receiving the coordinated beamforming trigger frame using the synchronized timing.

In an embodiment, as shown in block 2360, the extracted information includes information regarding a phase of the NDPA frame and the NDP frame. In this case, as shown in block 2365 and block 2370, respectively, the first AP may determine a certain phase to use for transmitting a data frame to a second STA that is associated with the first AP based on the information regarding the phase of the NDPA frame and the NDP frame and transmit the data frame to the second STA using the certain phase.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a station (STA) associated with a first access point (AP) operating a first basic service set (BSS) to participate in an overlapping basic service set (OBSS) channel sounding procedure, the method comprising:
receiving a null data packet announcement (NDPA) frame from the first access point (AP);
receiving a null data packet (NDP) frame transmitted by a second AP operating a second BSS, wherein the second AP transmitted the NDP frame in response to receiving the NDPA frame from the first AP;
generating channel state information for a link between the STA and the second AP based on the NDP frame;
receiving a trigger frame from the first AP that solicits channel state information; and
responsive to receiving the trigger frame, transmitting a channel state information feedback frame to the first AP that is meant to be overheard by the second AP, wherein the channel state information feedback frame includes the channel state information for the link between the STA and the second AP, wherein the channel state information feedback frame includes a multi-user exclusive beamforming report field that is repurposed to carry information other than multi-user exclusive beamforming report information because the channel state information feedback frame is meant to be overheard by the second AP, which is an OBSS AP with respect to the STA.

2. The method of claim 1, wherein the information that is carried in the multi-user exclusive beamforming report field includes at least part of the channel state information for the link between the STA and the second AP.

3. The method of claim 2, wherein the channel state information feedback frame is transmitted using a lower modulation coding scheme (MCS) compared to a MCS indicated in the trigger frame.

4. The method of claim 1, wherein the repurposing of the multi-user exclusive beamforming report field allows the channel state information for the link between the second STA and the second AP to be transmitted in fewer frames than if the multi-user exclusive beamforming report field was not repurposed.

5. The method of claim 1, wherein the information that is carried in the multi-user exclusive beamforming report field includes information indicating that nulling was not successfully performed during a previous coordinated beamforming performed by the first AP and the second AP.

6. The method of claim 1, wherein the information that is carried in the multi-user exclusive beamforming report field includes information regarding a received signal strength of the NDP frame at the STA.

7. The method of claim 1, wherein the information that is carried in the multi-user exclusive beamforming report field includes information regarding a carrier frequency offset (CFO) and a sampling frequency offset (SFO) of the NDPA frame and the NDP frame.

8. The method of claim 1, wherein the information that is carried in the multi-user exclusive beamforming report field includes information regarding a phase of the NDPA frame and the NDP frame.

9. The method of claim 8, wherein the information regarding the phase of the NDPA frame and the NDP frame include one or more of: phase difference information and phase noise information.

10. A method performed by a first access point (AP) operating a first basic service set (BSS) to participate in an overlapping basic service set (OBSS) channel sounding procedure with a second AP operating a second BSS, the method comprising:
receiving a null data packet announcement (NDPA) frame transmitted by the second AP;
responsive to receiving the NDPA frame, transmitting a null data packet (NDP) frame;
receiving a channel state information feedback frame transmitted by a station (STA) that is associated with the second AP, wherein the channel state information feedback frame includes channel state information for a link between the STA and the first AP that was generated by the STA based on the NDP frame, wherein the channel state information feedback frame includes a multi-user exclusive beamforming report field that is repurposed to carry information other than multi-user exclusive beamforming report information because the channel state information feedback frame is meant to be overheard by the first AP, which is an OBSS AP with respect to the STA;
extracting the information carried in the multi-user exclusive beamforming report field; and
performing coordinated beamforming with the second AP using the extracted information.

11. The method of claim 10, wherein the information carried in the multi-user exclusive beamforming report field includes at least part of the channel state information for the link between the STA and the first AP, wherein the performing the coordinated beamforming comprises:
applying nulling toward the STA using the channel state information for the link between the STA and the first AP.

12. The method of claim 10, wherein the channel state information feedback frame is received using a lower modulation coding scheme (MCS) compared to a MCS indicated in a trigger frame transmitted by the second AP that solicited the channel state information feedback frame.

13. The method of claim 10, wherein the repurposing of the multi-user exclusive beamforming report field allows the channel state information for the link between the second STA and the second AP to be received in fewer frames than if the multi-user exclusive beamforming report field was not repurposed.

14. The method of claim 10, wherein the information carried in the multi-user exclusive beamforming report field includes information indicating that nulling was not successfully performed during a previous coordinated beamforming performed by the first AP and the second AP, wherein the performing the coordinated beamforming comprises:
applying nulling toward the STA differently from how nulling was applied toward the STA in the previous coordinated beamforming performed by the first AP and the second AP.

15. The method of claim 10, wherein the information carried in the multi-user exclusive beamforming report field includes information regarding a received signal strength of the NDP frame at the STA, wherein the performing the coordinated beamforming comprises:
determining a transmit power to use for transmitting a data frame to a second STA that is associated with the first AP based on the information regarding the received signal strength of the NDP frame at the STA; and
transmitting a data frame to the second STA using the determined transmit power.

16. The method of claim 10, wherein the information carried in the multi-user exclusive beamforming report field includes information regarding a carrier frequency offset (CFO) and a sampling frequency offset (SFO) of the NDPA frame and the NDP frame, the method further comprising:
synchronizing timing between the first AP and the second AP based on the CFO and the SFO of the NDPA frame and the NDP frame.

17. The method of claim 16, wherein the performing the coordinated beamforming comprises:
receiving a coordinated beamforming trigger frame from the second AP; and
responsive to receiving the coordinated beamforming trigger frame, transmitting a data frame to a second STA that is associated with the first AP after an interframe space interval after receiving the coordinated beamforming trigger frame using the synchronized timing.

18. The method of claim 17, further comprising:
receiving a second NDPA frame transmitted by the second AP; and
responsive to receiving the second NDPA frame, transmitting a second NDP frame after an interframe space interval after receiving the second NDPA frame using the synchronized timing.

19. The method of claim 10, wherein the information that is carried in the multi-user exclusive beamforming report field includes information regarding a phase of the NDPA frame and the NDP frame, wherein the performing the coordinated beamforming comprises:
determining a certain phase to use for transmitting a data frame to a second STA that is associated with the first AP based on the information regarding the phase of the NDPA frame and the NDP frame; and
transmitting the data frame to the second STA using the certain phase.

20. The method of claim 19, wherein the information regarding the phase of the NDPA frame and the NDP frame includes one or more of: phase difference information and phase noise information.

21. A wireless device configured to implement a station (STA) associated with a first access point (AP) operating a first basic service set (BSS), the wireless device comprising:
a radio frequency transceiver;
a memory device storing a set of instructions; and
a processor coupled to the memory device, wherein the set of instructions, when executed by the processor, causes the STA to:
receive a null data packet announcement (NDPA) frame from the first access point (AP);
receive a null data packet (NDP) frame transmitted by a second AP operating a second BSS, wherein the second AP transmitted the NDP frame in response to receiving the NDPA frame from the first AP;
generate channel state information for a link between the STA and the second AP based on the NDP frame;
receive a trigger frame from the first AP that solicits channel state information; and
responsive to receiving the trigger frame, transmit a channel state information feedback frame to the first AP that is meant to be overheard by the second AP, wherein the channel state information feedback frame includes the channel state information for the link between the STA and the second AP, wherein the channel state information feedback frame includes a multi-user exclusive beamforming report field that is repurposed to carry information other than multi-user exclusive beamforming report information because the channel state information feedback frame is meant to be overheard by the second AP, which is an overlapping basic service set (OBSS) AP with respect to the STA.

22. A wireless device configured to implement a first access point (AP) operating a first basic service set (BSS), the wireless device comprising:
a radio frequency transceiver;
a memory device storing a set of instructions; and
a processor coupled to the memory device, wherein the set of instructions, when executed by the processor, causes the first AP to:
receive a null data packet announcement (NDPA) frame transmitted by a second AP operating a second BSS;
responsive to receiving the NDPA frame, transmit a null data packet (NDP) frame;
receive a channel state information feedback frame transmitted by a station (STA) that is associated with the second AP, wherein the channel state information feedback frame includes channel state information for a link between the STA and the first AP that was generated by the STA based on the NDP frame, wherein the channel state information feedback frame includes a multi-user exclusive beamforming report field that is repurposed to carry information other than multi-user exclusive beamforming report information because the channel state information feedback frame is meant to be overheard by the first AP, which is an OBSS AP with respect to the STA;
extract the information carried in the multi-user exclusive beamforming report field; and
perform coordinated beamforming with the second AP using the extracted information.
